(19) United States
(12) Patent Application Publication
(10) Pub. No.: US 2026/0115949 A1
(43) Pub. Date: Apr. 30, 2026

(54) HAIR CUTTING DEVICE WITH INTEGRAL MOTOR VIBRATION DAMPING

(71) Applicant: WAHL CLIPPER CORPORATION, Sterling, IL (US)

(72) Inventors: Steven Wayne ARNDT, Geneseo, IL (US); Curtis J. DE FRANG, Sterling, IL (US); Daniel Michael SAATHOFF, Sterling, IL (US)

(21) Appl. No.: 19/354,287

(22) Filed: Oct. 9, 2025

Related U.S. Application Data
(60) Provisional application No. 63/713,868, filed on Oct. 30, 2024.

(51) Int. Cl. B26B 19/38; B26B 19/06

(52) U.S. Cl. CPC B26B 19/3866; B26B 19/06

(57) ABSTRACT

A lid is provided for a hair clipper having a housing containing a motor. The lid includes a first lid portion formed of a first material; and a second lid portion formed of a second material different from the first material and configured for covering the motor as the housing is assembled, and for dampening vibrations generated by the motor.

### RELATED APPLICATION

The present application claims the benefit under 35 USC 119(e) of US Provisional Application No. 63/713,868 filed October 30, 2024, the entire contents of which are incorporated by reference herein.

### BACKGROUND

The present invention relates generally to electric hair cutting devices such as hair clippers and hair trimmers, referred to here collectively as hair clippers, and more specifically to structures for dampening motor vibrations in such devices.

Electric hair clippers include a moving blade that laterally reciprocates in relation to a stationary blade to perform a cutting action. Both the moving blade and the stationary blade have teeth, and both blades are collectively referred to as the clipper bladeset. Hair caught between the teeth of the blades is sheared through movement of the moving blade relative to the stationary blade.

Contemporary electric hair clippers also include an electric motor that is powered by an on-board battery, and/or via a supply voltage from an outlet. The motor is mechanically coupled to the moving blade to produce the reciprocation of the moving blade via one of a variety of different mechanical linkage formats (e.g. eccentric cam arrangements, pivot arm arrangements, etc.).

Most contemporary electric hair clippers are designed to hold or support the motor in a rigid housing around the motor’s front and rear motor bearings. To suppress vibration transferring to the housings, a thin rubber collar is often used around the circumference of the bearings. For additional vibration reduction, a piece of sponge rubber or similar sound absorbing material is often used between the motor and housing under light compression. Often, the sponge rubber is held in place by an internal hold down cover, which is then covered by the clipper housing lid. However, if the housing is significantly larger than the motor (creating a large dead air space) or the motor has significant clearance between the shaft and bearing, the motor vibration tends to resonate inside the housing causing amplified noise. Both vibration and noise are undesirable.

Vibration and noise occur in rotary motor hair clippers where an eccentric cam drives a blade along a linear reciprocating path. The eccentricity of the cam causes resonant frequencies at the points of contact between the motor and the housing, and transfers energy into vibration and noise that the user feels while the hair clipper is in use.

It has been found that in modern hair clippers, a combination of several factors, including motor power, housing construction, user behavior that results in devices being held for longer periods of time, the suppression of cutting device motor vibrations has become more important for improving user ergonomics. Also, manufacturers are pressured to more efficiently produce hair clippers that address user concerns, such as excessive motor vibrations. Contemporary efforts to reduce motor vibrations have proved unsatisfactory.

Thus, there is a need for improved vibration dampening for electric hair clippers that use rotary motors to reduce motor and housing vibrations of the device.

### SUMMARY

The above-listed need is met or exceeded by the present hair clipper housing, wherein a conventional motor vibration damping pad and the conventional hold down cover are replaced by a housing lid having an integral motor vibration damping structure. Through the use of a two-shot molding process, a first, relatively rigid housing material is combined with a second, resilient damping material into an integral housing lid member. Thus, a single clipper lid covers the clipper internals and includes an on-board motor vibration damper. Preferably, the motor vibration damper is specially configured for engaging the clipper motor and for dampening vibrations, while also enhancing air flow around the motor.

More specifically, a lid is provided for a hair clipper having a housing containing a motor. The lid includes a first lid portion formed of a first material; and a second lid portion formed of a second material different from the first material and configured for covering the motor as the housing is assembled, and for dampening vibrations generated by the motor.

In an embodiment, the second material is more resilient than the first material, and the second lid portion is integrally formed with the first lid portion. Preferably, the second lid portion includes a motor dampening structure configured with sound dampening formations. In an embodiment, the sound dampening formations include a plurality of spaced, parallel ridges dimensioned for contacting the motor, and defining air passages therebetween. Preferably, the ridges are arcuate in shape. In an embodiment, the second lid portion includes at least one exposed gripping surface for accommodating a user’s hand during operation.

In another embodiment, a hair clipper is provided, including, a housing including a lower housing portion accommodating a clipper motor, an upper housing portion securable to the lower housing portion and enclosing the motor, the upper housing portion including a clipper lid with a first lid portion formed of a first material, and a second lid portion formed of a second material different from the first material and configured for covering the motor as the housing is assembled by the upper housing portion being secured to the lower housing portion, and the second lid portion dampening vibrations generated by the motor.

In an embodiment, the housing includes at least one cosmetic covering mountable to the clipper lid. In an embodiment, the at least one cosmetic covering includes an outer cosmetic covering secured to an inner cosmetic covering.

### BRIEF DESCRIPTION OF THE DRAWINGS

FIG. 1 is an exploded perspective view of a prior art hair clipper;

FIG. 2 is a top perspective view of the present hair clipper lid;

FIG. 3 is an underside perspective view of the hair clipper lid of FIG. 2;

FIG. 4 is an exploded perspective view of the hair clipper lid of FIG. 2;

FIG. 5 is a side perspective view of an underside the hair clipper lid of FIG. 2;

FIG. 6 is a top plan view of the hair clipper lid of FIG. 2; and

FIG. 7 is an enlarged fragmentary underside perspective view of the hair clipper lid of FIG. 2.

### DETAILED DESCRIPTION

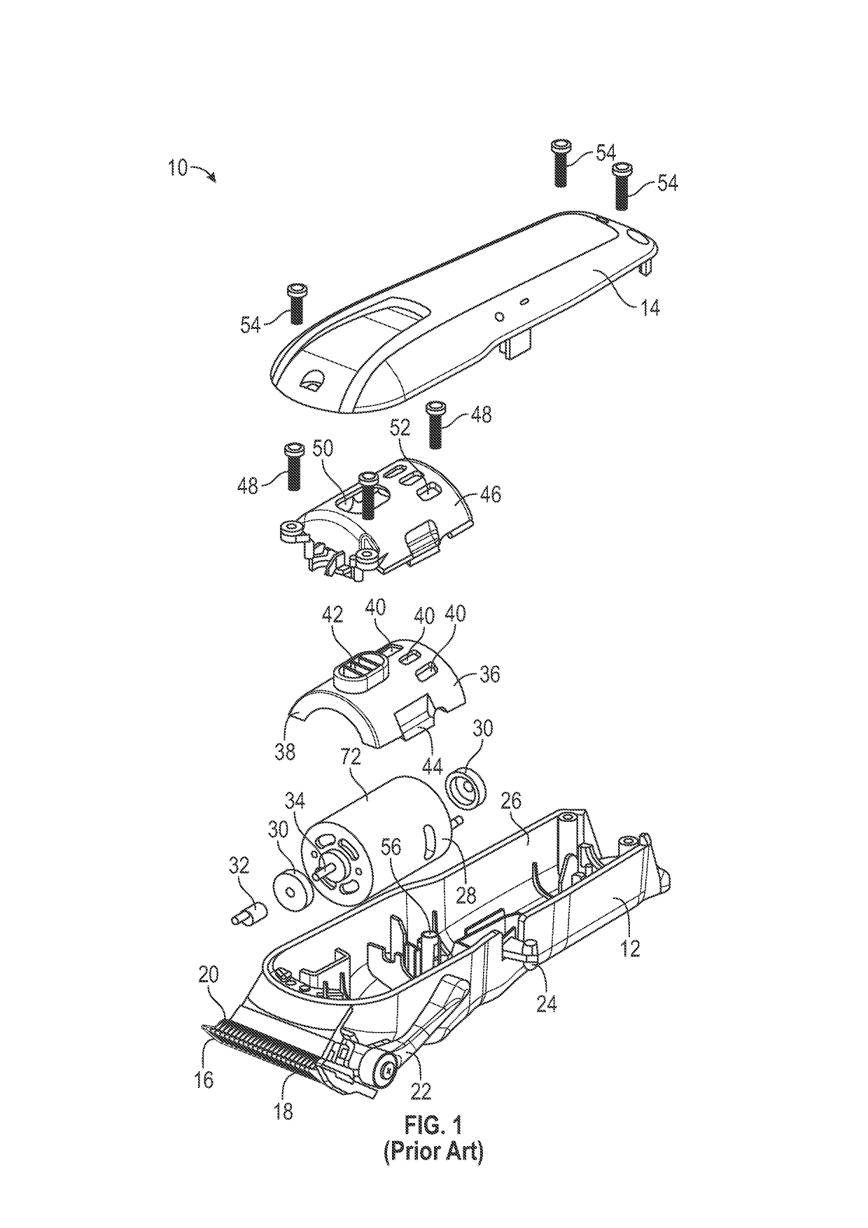

Referring now to FIG. 1, a prior art hair clipper is generally designated 10, and includes a lower housing 12 and an upper housing 14, the latter also referred to as a clipper lid. Attached to the lower housing 12 is a bladeset 16 including a stationary blade 18 and a laterally-reciprocating moving blade 20. A stationary blade adjustor lever 22 is operationally engaged with the bladeset 16, and a clipper on/off switch 24 is also mounted to the lower housing 12.

The lower housing 12 defines an inner chamber 26 into which is placed an electric motor 28. Preferably, a pair of rubber collars 30 are placed at ends of the motor 28 for absorbing vibration and reducing operational noise. An eccentric cam 32 is engaged on a motor armature or drive shaft 34 for causing lateral reciprocation of the moving blade 20 as is well known in the art.

A flexible motor vibration damper 36 is made of resilient, rubber or rubber-like material and has at least one radially-projecting flange 38 for enhancing seating of the damper 36 upon the motor 28. Heat generated by the motor 28 during clipper operation is dissipated through openings 40 as well as from a ribbed, vertically-projecting portion 42 preferably formed with the vibration damper 36. Also included on the vibration damper 36 is at least one protrusion or clip 44 that engages a complementary receptacle (not shown) on the lower housing 12 for securing the damper in place upon the motor 28.

A relatively rigid motor cover 46 is secured to the lower housing 12 by a plurality of fasteners 48 and is configured for covering the vibration damper 36 and holding it in place. Preferably, the motor cover 46 exerts a compressive force on the vibration damper 36. An opening 50 on the motor cover 46 accommodates the raised ribbed portion 42. Also, the motor cover 46 is provided with ventilation ports 52 in registry with the openings 40 in the vibration damper 36 for enhancing the escape of heat generated through motor operation. The upper housing or lid 14 is held in place upon the lower housing 12 via fasteners 54. When installed, the upper housing 14 encloses the motor 28, the vibration damper 36 and the motor cover 44. As is known in the art, the lower housing 12 also includes integral formations 56 used to secure a battery, operational circuit boards, power cords, and the like which are mounted in the housing chamber 26. Further details of the hair clipper 10 are disclosed in commonly-assigned US Patent No. 9,038,276 which is incorporated by reference herein.

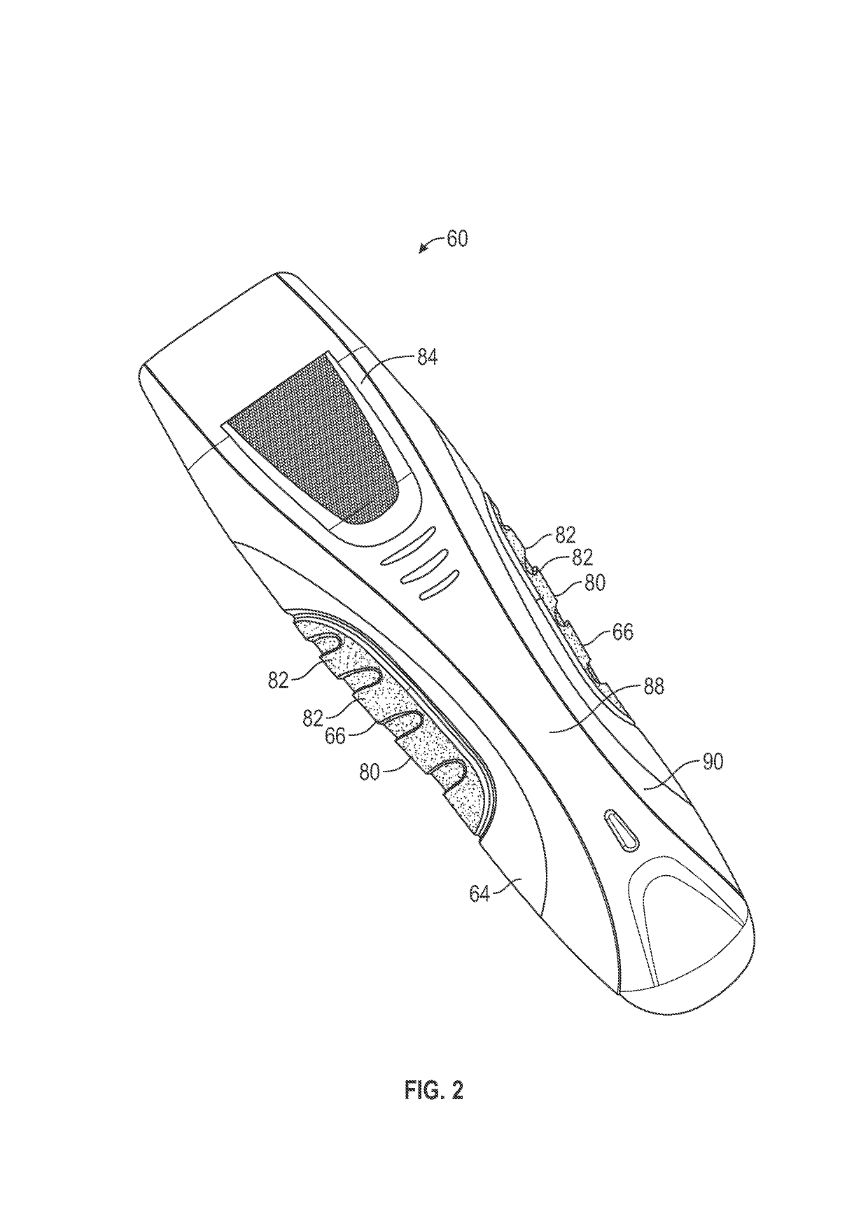

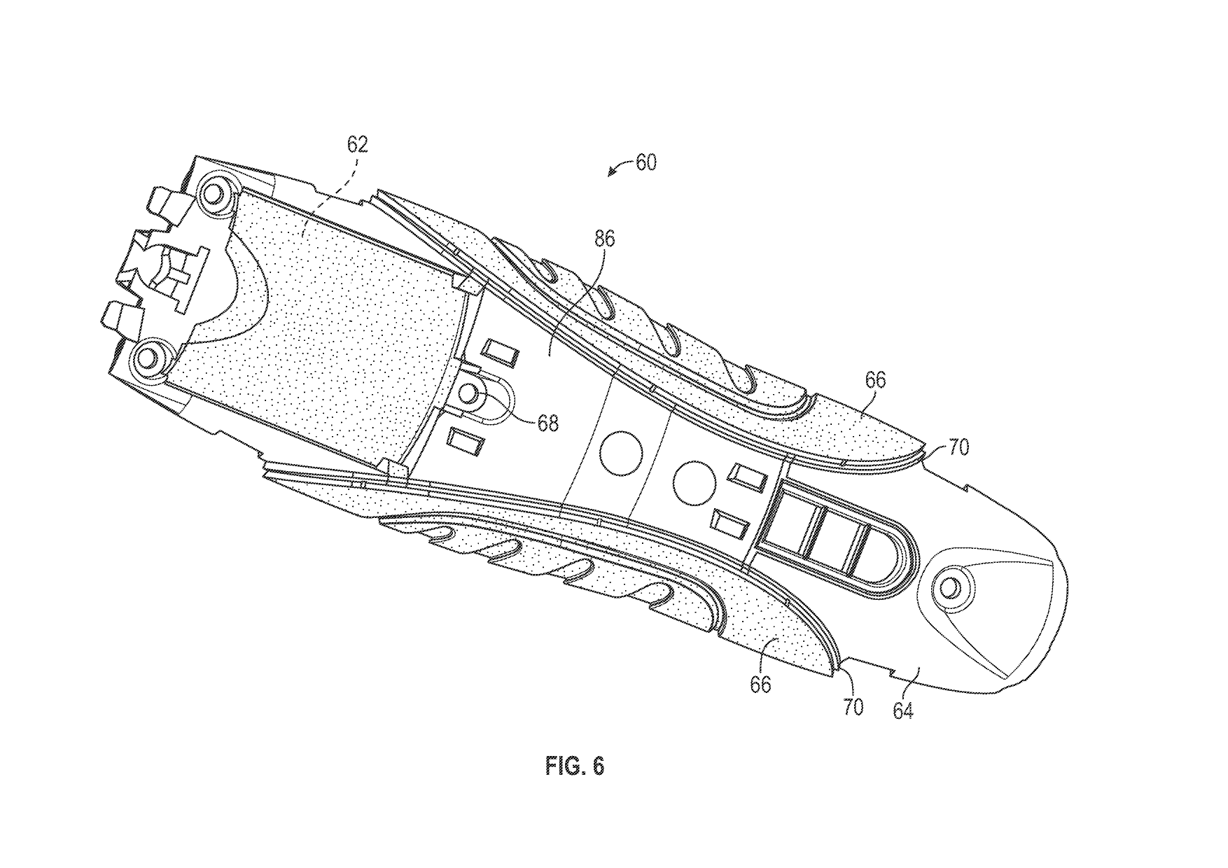

Referring now to FIGS. 2-6, addressing the above-listed need to improve the suppression of hair clipper operational vibrations and noise, the present hair clipper lid or upper housing is generally designated 60. It is contemplated that the present hair clipper lid is mountable on the hair clipper 10 using the fasteners 54 and replaces the vibration damper 36, the motor cover 46 and the upper housing lid 14, all separate components, with a single component. Accordingly, compared to the hair clipper 10 described above, the present hair clipper lid 60 features manufacturing and assembly simplification and enhanced efficiency.

A feature of the present hair clipper lid 60 is an integrally-formed motor vibration damper, generally designated 62. In a preferred embodiment, the hair clipper lid 60 has a first lid portion 64 formed of a first material; and a second lid portion 66 (shown in the FIGs. with hatched shading) formed of a second material different from the first material and configured for covering the motor 28 as the housing 12, 14 is assembled, and for dampening vibrations generated by the motor. The second lid portion 66 includes the motor vibration damper 62.

It is preferred that the first lid portion 64 is molded initially, and is made of a relatively rigid plastic material, so that a satisfactorily strong clipper housing lid is created, having standard durability for self-support and operator usage. In other words, the first lid portion 64 forms the skeleton or backbone of the clipper lid 60. Further, the first lid portion 64 is provided with mounting structures 68 such as bosses for receiving the fasteners 54, and wall structures 70 defining the limits of the first lid portion and also defining a border of the second lid portion 66.

It is also preferred, for achieving the goal of reduced motor vibration and noise, that the second material of the second lid portion 66 is more resilient and softer than the first lid material of the first lid portion 64. More specifically, the first lid portion 64 is molded of a plastic material such as ABS or the like, having a Rockwell R scale hardness range of 80 to 116. In contrast, the relatively resilient, rubber-like second lid portion 66 has a Shore A scale hardness range of 40 to 55. The present lid 60 is formed in a two-step molding process, where the first lid portion 64, with the more rigid material, is molded first, then the second lid portion 66, made of the relatively softer material, is molded on top of and partially surrounding the first lid portion. Such overmolding of components also referred to as a double shot technique, is known to skilled practitioners in the hair clipper production art. In the formation of the present clipper lid 60, it will be understood that once the first lid portion 64 is formed of the first material, the second lid portion 66 is integrally molded around the first lid portion, so that a single, integral two-part lid is formed.

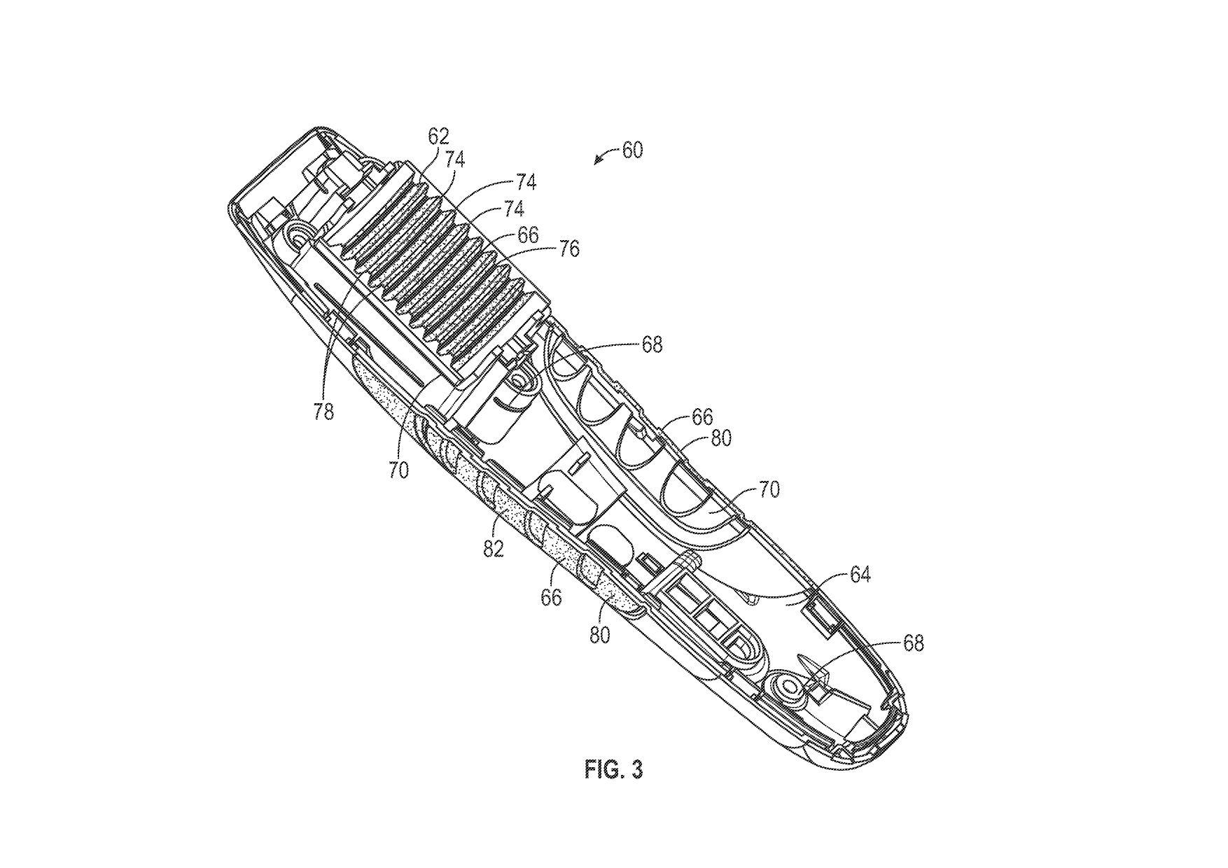

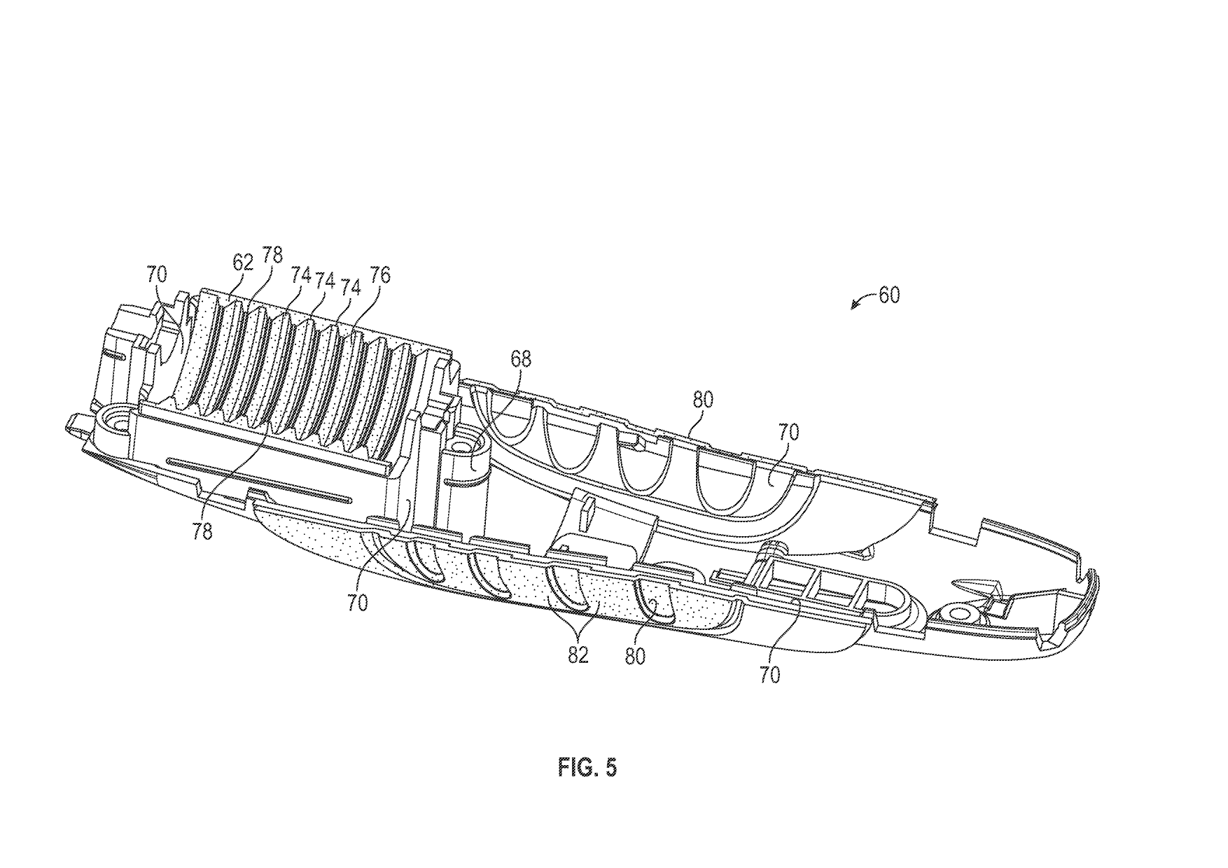

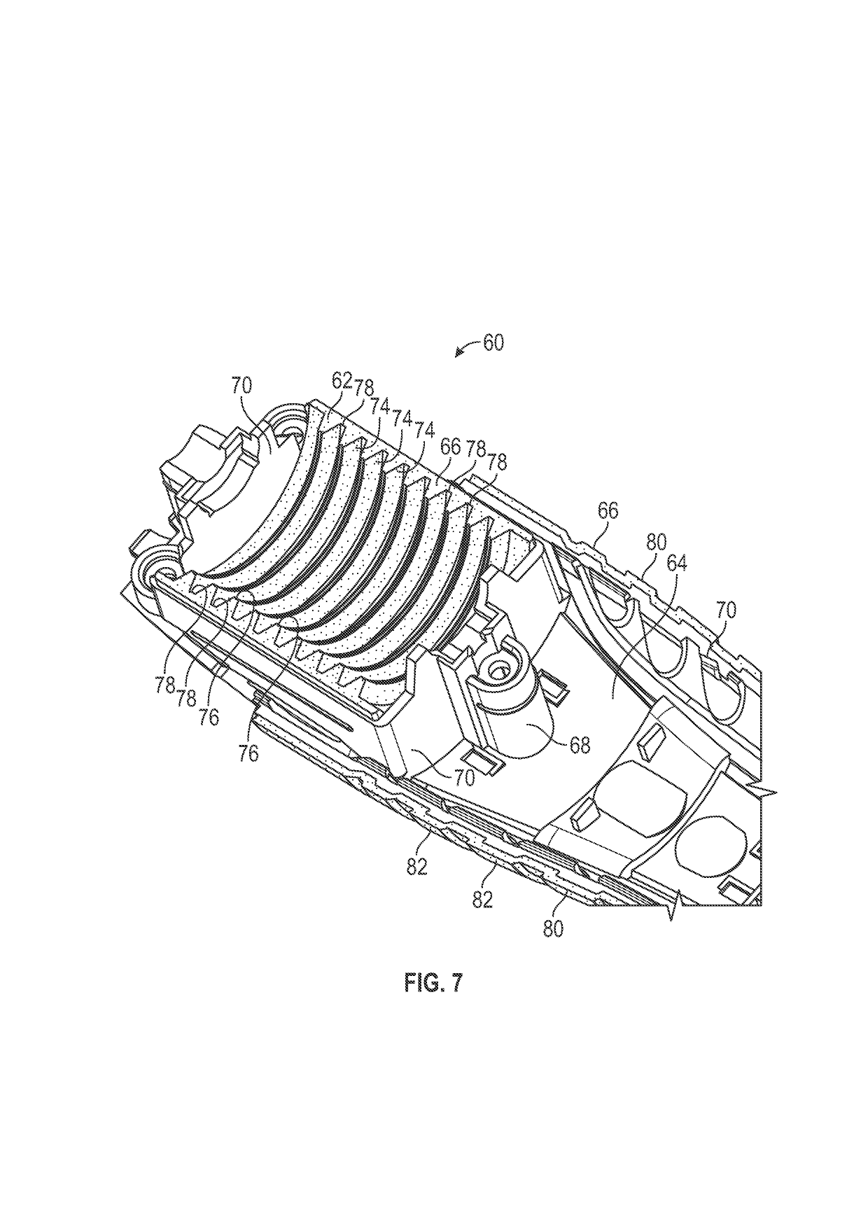

Referring now to FIGS. 3, 5 and 7, an important feature of the second lid portion is the motor damper formation 62, which is configured for enveloping an upper portion 72 of the motor 28 (FIG. 1) upon assembly of the clipper housing 12, 60. The present motor damper formation 62 includes a plurality of sound dampening formations 74, which in the preferred embodiment, are a plurality of peaked ridges 76 in spaced, parallel orientation. Also, the ridges 76 define spaces or air passages 78 between them, so that air flow around the motor 28 is enhanced for cooling purposes. As seen in FIGS. 5 and 7, the ridges 76 are arcuate in shape for more complete envelopment of the motor 28.

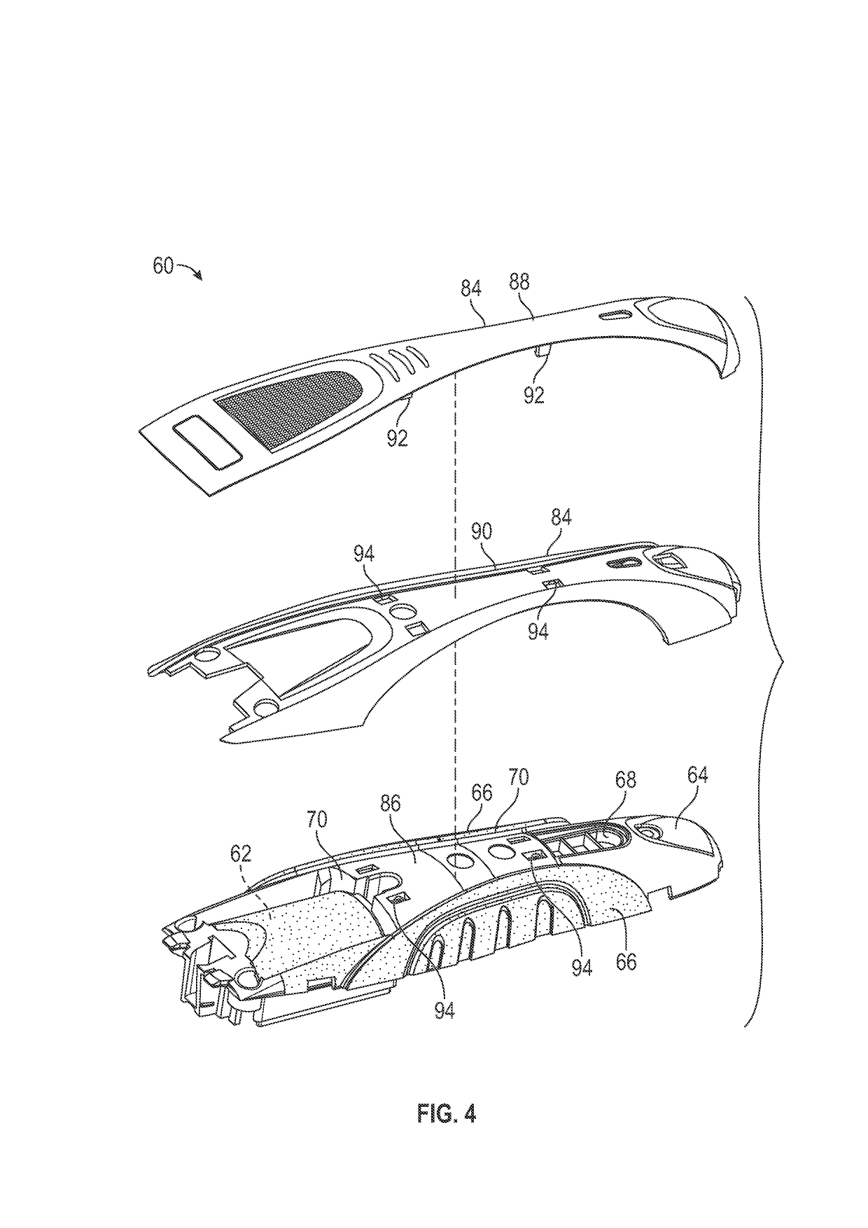

Referring now to FIGS. 4-6, another feature of the second lid portion 66 is that the more resilient, second material, is also used to form gripping portions 80 that are exposed on the exterior of the clipper lid 60. In the preferred embodiment, there are two gripping portions 80, one on each side of the clipper lid 60, and each such gripping portion is textured for enhanced gripping, with a plurality of raised formations 82. As is the case with the motor damper formation 62, the gripping portions 80 are integral with the motor damper formation 62 and also with the present clipper lid 60.

Referring now to FIGS. 2 and 4, another feature of the present clipper lid 60 is that optional cosmetic coverings or inserts 84 are attachable to an upper surface 86 of the clipper lid. In an embodiment, a first cosmetic insert 88 is engageable upon a second cosmetic insert 90. Preferably, the first cosmetic insert 88 nests inside the second cosmetic insert 90 to achieve a flush assembled surface for the lid 60. Suitable barbed pegs or clips 92 and opening 94 construction is contemplated for securing the cosmetic inserts 88, 90 together as by a snap fit, and also to the upper surface 86 of the lid 60. The use of chemical adhesives or ultrasonic molding is also contemplated for assembling the present clipper lid 60. It is envisioned that the first cosmetic insert 88 is provided in a first color or material, and the second cosmetic insert 90 is provided in a second color or material so that a variety of aesthetic appearances are possible for the clipper lid 60.

Upon assembly of the present clipper lid 60, it is used to assemble the hair clipper 10 as shown in FIG. 1. However, by using the present clipper lid 60, material and labor costs are significantly reduced in comparison to the conventional hair clipper 10.

While a particular embodiment of the present hair cutting device with integral motor vibration damping has been described herein, it will be appreciated by those skilled in the art that changes and modifications may be made thereto without departing from the invention in its broader aspects and as set forth in the following claims.

1. A lid for a hair clipper having a housing containing a motor, said lid comprising:
a first lid portion formed of a first material; and
a second lid portion formed of a second material different from said first material and configured for covering the motor as the housing is assembled, and for dampening vibrations generated by the motor.

2. The lid of claim 1, wherein said second material is more resilient than said first material, and said second lid portion is integrally formed with said first lid portion.

3. The lid of claim 1, wherein said second lid portion includes a motor dampening structure configured with sound dampening formations.

4. The lid of claim 3, wherein said sound dampening formations include a plurality of spaced, parallel ridges dimensioned for contacting the motor, and defining air passages therebetween.

5. The lid of claim 4, wherein said ridges are arcuate in shape.

6. The lid of claim 3, wherein said second lid portion includes at least one exposed gripping surface for accommodating a user’s hand during operation.

7. The lid of claim 1, further including at least one cosmetic covering mountable to said clipper lid.

8. The hair clipper of claim 7, wherein the at least one cosmetic covering includes an outer cosmetic covering secured to an inner cosmetic covering.

9. A hair clipper, comprising:
a housing including a lower housing portion accommodating a clipper motor;
an upper housing portion securable to said lower housing portion and enclosing said motor;
said upper housing portion including a clipper lid with a first lid portion formed of a first material; and
a second lid portion formed of a second material different from said first material and configured for covering said motor as said housing is assembled by said upper housing portion being secured to said lower housing portion, and said second lid portion dampening vibrations generated by said motor.

10. The hair clipper of claim 9, further including at least one cosmetic covering mountable to said clipper lid.

11. The hair clipper of claim 10, wherein the at least one cosmetic covering includes an outer cosmetic covering secured to an inner cosmetic covering.

12. The hair clipper of claim 9, wherein said second material is more resilient than said first material, and said second lid portion is integrally formed with said first lid portion.

13. The hair clipper of claim 9, wherein said second lid portion includes a motor dampening structure configured with sound dampening formations.

14. The hair clipper of claim 13, wherein said sound dampening formations include a plurality of spaced, parallel ridges dimensioned for contacting the motor, and defining air passages therebetween.

15. The hair clipper of claim 14, wherein said ridges are arcuate in shape.

16. The hair clipper of claim 9, wherein said second lid portion includes at least one exposed gripping surface for accommodating a user’s hand during operation.
